(19) United States
(12) Patent Application Publication
(10) Pub. No.: US 2009/0125894 A1
(43) Pub. Date: May 14, 2009

(54) Highly scalable parallel static single assignment for dynamic optimization on many core architectures

(76) Inventors: Sreekumar R. Nair, Santa Clara, CA (US); Youfeng Wu, Palo Alto, CA (US)

Correspondence Address: PEARL COHEN ZEDEK LATZER, LLP, 1500 BROADWAY, 12TH FLOOR, NEW YORK, NY, 10036, US

(21) Appl. No.: 11/984,139

(22) Filed: Nov. 14, 2007

(51) Int. Cl. G06F 9/45

(52) U.S. Cl. 717/156

(57) ABSTRACT

A method, system, and computer readable medium for converting a series of computer executable instructions in control flow graph form into an intermediate representation, of a type similar to Static Single Assignment (SSA), used in the compiler arts. The indeterminate representation may facilitate compilation optimizations such as constant propagation, sparse conditional constant propagation, dead code elimination, global value numbering, partial redundancy elimination, strength reduction, and register allocation. The method, system, and computer readable medium are capable of operating on the control flow graph to construct an SSA representation in parallel, thus exploiting recent advances in multi-core processing and massively parallel computing systems. Other embodiments may be employed, and other embodiments are described and claimed.

### BACKGROUND OF THE INVENTION

In compiler design, static single assignment form (often abbreviated as SSA form or SSA) is an intermediate representation (IR) in which every variable is assigned exactly once. Existing variables in the original IR are split into versions, new variables typically indicated by the original name with a subscript, so that every definition gets its own version. In SSA form, use-def chains are explicit and each contains a single element. The primary usefulness of SSA comes from how it simultaneously simplifies and improves the results of a variety of compiler optimizations, by simplifying the properties of variables. Compiler optimization algorithms which are either enabled or strongly enhanced by the use of SSA include for example: constant propagation, sparse conditional constant propagation, dead code elimination, global value numbering, partial redundancy elimination, strength reduction, and register allocation.

The ever-increasing complexity in the microprocessor architectures, and the subsequent increase in hardware costs, has recently led many industrial and academic researchers to consider software solutions in lieu of complex hardware designs to address performance and efficiency problems (such as execution speed, battery life, memory bandwidths etc.). One such problem arises in the compilation of source code, a computationally intensive process that has heretofore not exploited recent advancements in multi-core processor design and highly parallel computing systems using communication fabrics. The SSA algorithm, heretofore used by compilers in converting human readable code to machine executable code, is not inherently parallel. That is, for a given region of code, the SSA representation must be constructed sequentially, using a single thread (or processor).

### BRIEF DESCRIPTION OF THE DRAWINGS

The subject matter regarded as the invention is particularly pointed out and distinctly claimed in the concluding portion of the specification. The invention, however, both as to organization and method of operation, together with objects, features, and advantages thereof, may be best understood by reference to the following detailed description when read with the accompanied drawings in which:

FIG. 1 shows a control flow graph (CFG) of code blocks in which variables are assigned and passed.

FIG. 2A shows the control flow graph (CFG) after the renaming operation of the classical SSA algorithm.

FIG. 2B shows the control flow graph (CFG) of the formation of the Ø-operand, according to the classical SSA algorithm.

FIG. 2C shows the control flow graph (CFG) in which the Ø-operand is chained for use, according to the classical SSA algorithm.

FIG. 3A shows a control flow graph (CFG) after renaming definitions and creating dummy Ø-operands, according to one embodiment of the present invention.

FIG. 3B shows a control flow graph (CFG) after defining the Ø-operands, according to one embodiment of the present invention.

FIG. 3C shows a control flow graph (CFG) after simplifying Ø-operands, according to an embodiment of the present invention.

FIG. 4 shows a block diagram of a system, according to an embodiment of the invention.

### DETAILED DESCRIPTION

In the following detailed description, numerous specific details are set forth in order to provide a thorough understanding of the invention. However it will be understood by those of ordinary skill in the art that the present invention may be practiced without these specific details. In other instances, well-known methods, procedures, components and circuits have not been described in detail so as not to obscure the present invention.

Unless specifically stated otherwise, as apparent from the following discussions, it is appreciated that throughout the specification discussions utilizing terms such as “processing,” “computing,” “calculating,” “determining,” or the like, refer to the action and/or processes of a computer, processor, or computing system, or similar electronic computing device, that manipulates and/or transforms data represented as physical, such as electronic, quantities within the computing system's registers and/or memories into other data similarly represented as physical quantities within the computing system's memories, registers or other such information storage, transmission or display devices. In addition, the term “plurality” may be used throughout the specification to describe two or more components, devices, elements, parameters and the like.

It should be understood that the present invention may be used in a variety of applications. Although the present invention is not limited in this respect, the circuits and techniques disclosed herein may be used in many apparatuses such as personal computers, network equipment, stations of a radio system, wireless communication system, digital communication system, satellite communication system, and the like.

Embodiments of the invention may include a computer readable storage medium, such as for example a memory, a disk drive, or a “disk-on-key”, including instructions which when executed by a processor or controller, carry out methods disclosed herein.

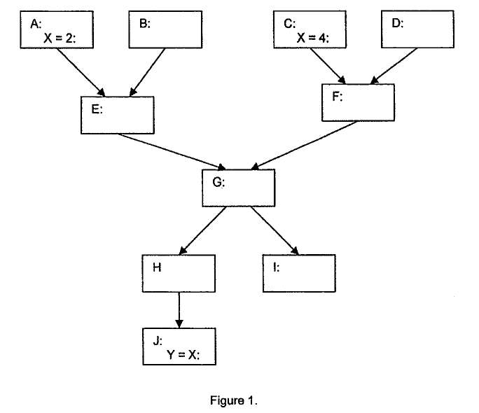

In FIG. 1, a typical control flow graph (CFG) is displayed, in which each lettered block A-J might contain, for example, a block of code containing a series of computer executable instructions such as variable assignment statements (e.g. X=2, Y=X). The flow of control between the blocks is determined by the arrows which may show, for example, the order in which these blocks are processed by a computer system, as well as any dependencies caused by the passing of variables and other data to a block.

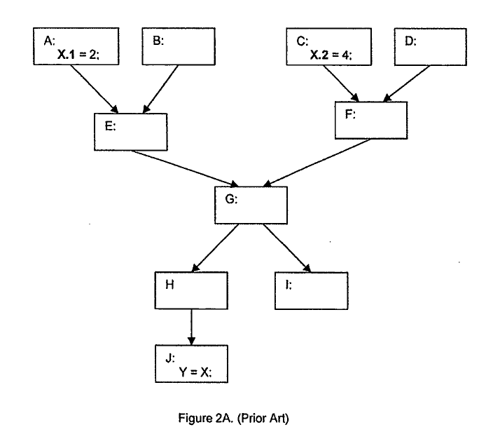

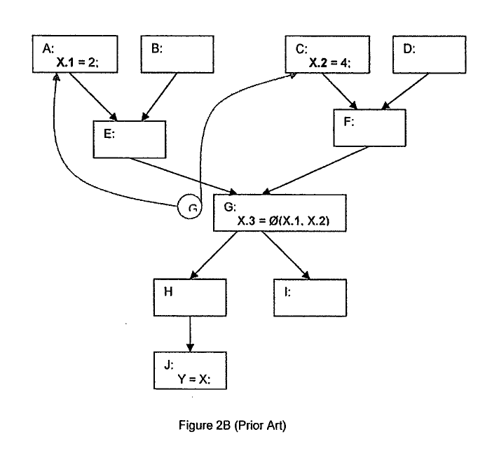

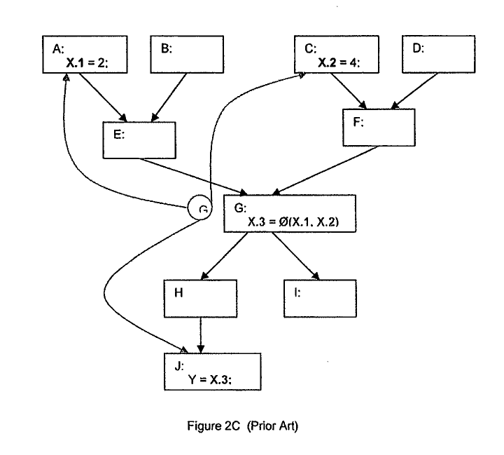

In FIG. 2A, the first step of the classical SSA algorithm is shown. Here, variables of the same designation in different code blocks (e.g. X) are renamed to a unique identifier, such as X.1 and X.2.

In FIG. 2B, the classical SSA algorithm is shown performing the second step of forming the Ø-operand (“phi-operand”). The Ø-operand denotes a condition in which the value of a variable is determined by which path the flow has taken to arrive at the current block. Thus, at block G, variable X may have a value of either 2 or 4 depending on how block G was reached (assuming no other intervening statements). This indeterminate state is captured as a Ø-operand in a statement such as X.3=Ø(X.1, X.2), and the Ø-operand for block G (of variable X) is denoted by the circled G and its arrows denoting dependency relationships, as shown in FIG. 2B. The Ø-operand is inserted in blocks determined according to the concept of a dominance frontier, the calculation of which is well known in the prior art, requiring a traversal of blocks using a single processor or core.

In FIG. 2C, the Ø-operand generated in FIG. 2b is chained to use, according to the classical SSA algorithm. Here, the value of X, expressed as a Ø-operand or its equivalent X.3, is propagated down through blocks dependent on block G (i.e. H, I, and J) and replaces any reference to X, as shown in block J. A traversal of blocks in the graph is also required in this step such that this operation cannot be performed using multiple processors or cores.

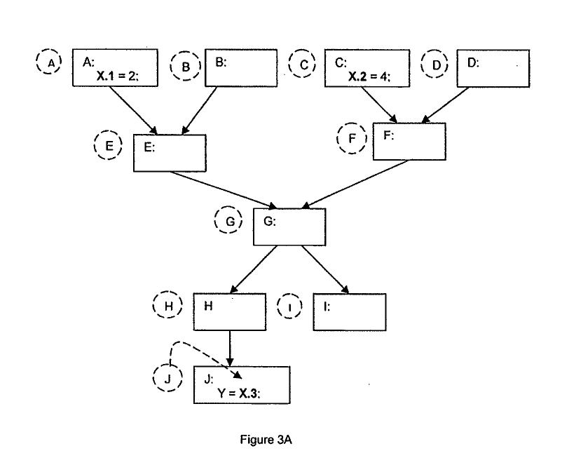

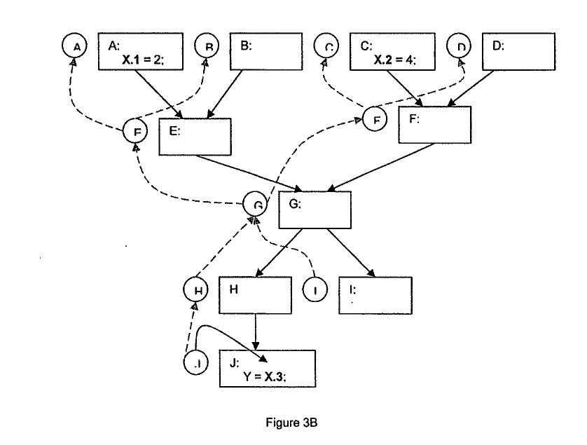

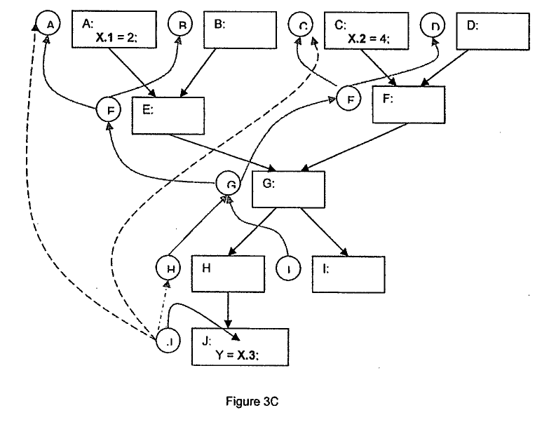

Referring now to FIG. 3A, the control flow graph (CFG) is shown after three operations, according to one embodiment of the invention. The first operation may include renaming each variable of the same designation in different code blocks (e.g. X) to a unique identifier, such as X.1, X.2, and X.3. This operation may be achieved in an ordered and sequential fashion, or may for example employ a synchronization mechanism to coordinate between multiple threads running in parallel. Additionally, Ø-operands may be allocated for each variable (e.g. X) at each node, although these Ø-operands need not be defined at this point. These “dummy” Ø-operands for each block are denoted as circled letters corresponding to their respective block letters, as shown in FIG. 3A. Furthermore, the undefined Ø-operand may be chained for use to the variable Y, as shown in block J. All the operations shown in FIG. 3A may be unordered and hence parallelizable

In FIG. 3B, the control flow graph (CFG) is shown after the Ø-operands are resolved (trivially) by looking one level up to form the definitions, according to one embodiment of the invention. Thus, as denoted by the dotted arrows in FIG. 3B, the Ø-operands may be defined as: E=Ø(A,B), F=Ø(C,D), G=Ø(E,F), H=Ø(G), I=Ø(G), and J=Ø(H), wherein A, for example, may be defined as X.1, with respect to the variable X. Note that the variable (e.g. X) need not be declared or defined in a Ø-operand's predecessor block. Thus, the Ø-operand of E may be defined by linking together the Ø-operands of A and B, regardless of whether X was declared or defined in block B. One advantage of this approach is that these Ø-operand definitions may be processed in any order and still be correct. The result is a fully parallelized algorithm, capable of being executed in a multi-core or multiprocessor environment. After this operation is performed, the complete SSA algorithm is available to be performed, although some Ø-operands may need to be dereferenced many times to get to the component definitions. At this point, all of the steps used to create the intermediate SSA representation in the compilation process, as described herein, may be processed in a parallel fashion, using multiple cores or processors.

In FIG. 3C an optional simplification operation of Ø-operands may be performed, according to one embodiment of the invention. The long dashed arrows in FIG. 3C shows how the Ø-operand for block J may be simplified to its most basic form. Thus, J=Ø(Ø(Ø(Ø(A,B),Ø(C,D)))) may be reduced to J=Ø(A,C) by reducing the number of nested Ø-operands. However, such a simplification operation may require that the Ø-operand be locked before simplifying it, to ensure that simplification of other Ø-operands do not accidentally attempt to simplify this Ø-operand multiple times (concurrently). Nevertheless, this simplification operation may be unordered, and thus able to be performed in parallel oil multiple processors or cores. This simplification step, when executed in parallel, may be faster than executing the same simplification step in sequential fashion in a single thread (or processor), especially if a locking mechanism is used.

The operations for creating an intermediate representation from a control flow graph of computer executable instructions, herein described with the figures depicting one embodiment of the present invention, may thus be summarized as follows according to one embodiment of the invention:

For each node representing a distinct block of code (e.g., basic block) in a control flow graph perform the following:
a. Rename definitions of identical variable names to have unique names,
b. For every variable that is live-in (used before it is defined in a prior block) pre-allocate an undefined Ø-operand,
c. Use the pre-allocated Ø-operands as definitions for every live-in use of the variables, and
d. Propagate the live definition of each variable out of the block—the live definition may be the (undefined) Ø-operand corresponding to the live-in variables.

For each node in the CFG (basic block), if any variable is live-through this block (e.g., not defined and not used in this block) then create Ø-operands for them as well, and mark them as live definitions out of the block.

For each node in the CFG (basic block), look at the live definition of each variable out of each predecessor block and merge their definitions into the Ø-operand for the variable in the current block. For example, while processing block E, one may look to blocks A and B and get the live definitions of X and insert links in the Ø-operand for X inside E.

For each node in the CFG (basic block), for every true live-in Ø-operand, simplify it by looking up the reference chains of dependencies until the process or device hits the leaf (or terminal) definitions and arranges them into the current Ø-operand. Thus when the Ø-operand in J is simplified, the reference chains are traversed past nodes H, G, E, and F to get the component definitions from A and C such that the definition becomes J=Ø(A,C).

Once the Ø-operands have been created, defined, and optionally simplified, the result is an intermediate representation capable of being processed (and optimized) by a compiler into machine code, or interpreted by an interpreter for use with a computing device. In one embodiment, the intermediate representation may be processed by a compiler. Further, the intermediate representation may be processed into compiled code, stored, and executed by a processor.

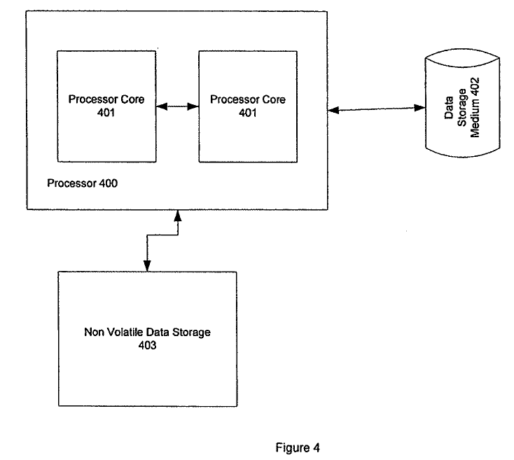

FIG. 4 shows a system according to one embodiment of the present invention. In one embodiment of the present invention, operations described herein (or a subset thereof) may be performed for example through the use of a series of processor executable instructions, for example stored on a processor readable storage medium 402. Processor readable storage medium 402 may be for example a memory (e.g., a RAM), a long term storage device (e.g., a disk drive), or another medium such as a memory such as a “disk on key”. The system may also employ, and operations discussed herein may be performed by, a controller or processor 400 which may include one or more processor cores 401. Additionally, the system may include volatile memory 403 such as RAM. It is to be understood that the system may also include multiple processors 400, each processor 400 having one or more cores 401. In other embodiments, however, dedicated hardware units such as specialized processors or logic units may be employed to perform some or all of these operations. The storage devices disclosed herein may be used to store compiled code, or intermediate data structures used to form compiled code.

The highly parallel nature of these operations may allow for greater scalability of hardware resources, such that the speed of compilation may be proportional to the number of processing units employed. Furthermore, embodiments of the present invention may be used in both static and dynamic compilation (including just-in-time variants thereof), thereby decreasing development turnaround for static compilation and improving execution time for dynamic compilation.

The present invention has been described with certain degree of particularity. Those versed in the art will readily appreciate that various modifications and alterations may be carried out without departing from the scope of the following claims:

1. A method for creating an intermediate representation of a control flow graph containing blocks of computer executable instructions, the method comprising:
renaming definitions of variables within a block of computer executable instructions to include unique variable identifiers, for each block in the control flow graph;
allocating an undefined Ø-operand for each of the variables that is live-in in that block, for each block in the control flow graph;
using the allocated Ø-operands as live definitions for every live-in use of its corresponding variable in that block, for each block in the control flow graph;
propagating the live definitions of each variable out of the block, for each block in the control flow graph; and
processing the intermediate representation with a compiler executed on a processor.

2. The method of claim 1, further comprising:
creating Ø-operands for any variable that is not used and not defined within a block, for each block in the control flow graph; and
marking each created Ø-operand as live definitions out of the block, for each block in the control flow graph.

3. The method of claim 2, further comprising:
merging the live definitions of each variable in the current block's predecessor blocks into the Ø-operand for the corresponding variable in the current block, for each block in the control flow graph.

4. The method of claim 3, further comprising:
traversing the control flow graph until the leaf definitions; and
reducing the number of any nested Ø-operands to a base representation in the live-in Ø-operands for each block in the control flow graph by arranging the leaf definitions into the current live-in Ø-operands.

5. The method of claim 1, comprising performing the operations of renaming definitions of variables, allocating undefined Ø-operands, using the allocated Ø-operands as live definitions, propagating the live definitions, and processing the intermediate representation with a compiler, for each block in the control flow graph in parallel.

6. The method of claim 1, comprising producing compiled code using the intermediate representation.

7. A system for creating an intermediate representation of a control flow graph containing blocks of computer executable instructions, the system comprising:
a plurality of processor cores; and
a processor readable storage medium containing the blocks of computer readable instructions represented as a control flow graph,
wherein the plurality of processor cores are to:
rename definitions of variables within a block of computer executable instructions to include unique variable identifiers, for each block in the control flow graph;
allocate an undefined Ø-operand for each of the variables that is live-in in that block, for each block in the control flow graph;
use the allocated Ø-operands as live definitions for every live-in use of its corresponding variable in that block, for each block in the control flow graph; and
propagate the live definitions of each variable out of the block, for each block in the control flow graph.

8. The system of claim 7, wherein the plurality of processor cores is further configured to:
create Ø-operands for any variable that is not used and not defined within a block, for each block in the control flow graph; and
mark each created Ø-operand as live definitions out of the block, for each block in the control flow graph.

9. The system of claim 8, wherein the plurality of processor cores is further configured to:
merge the live definitions of each variable in the current block's predecessor blocks into the Ø-operand for the corresponding variable in the current block, for each block in the control flow graph.

10. The system of claim 9, wherein the plurality of processor cores is further configured to:
traverse the control flow graph until the leaf definitions; and
reduce the number of nested Ø-operands to a base representation in the live-in Ø-operands for each block in the control flow graph by arranging the leaf definitions into the current live-in Ø-operands.

11. The system of claim 7, wherein the plurality of processor cores are configured to perform the operations of renaming definitions of variables, allocating undefined Ø-operands, using the allocated Ø-operands as live definitions, propagating the live definitions, and processing the intermediate representation with a compiler, for each block in the control flow graph in parallel.

12. A processor-readable storage medium having stored thereon instructions that, if executed by a processor, cause the processor to perform a method comprising:
renaming definitions of variables within a block of computer executable instructions to include unique variable identifiers, for each block in a control flow graph;
allocating an undefined Ø-operand for each of the variables that is live-in in that block, for each block in the control flow graph;
using the allocated Ø-operands as live definitions for every live-in use of its corresponding variable in that block, for each block in the control flow graph; and
propagating the live definitions of each variable out of the block, for each block in the control flow graph.

13. The processor-readable storage medium of claim 12, further comprising the instructions of:
creating Ø-operands for any variable that is not used and not defined within a block, for each block in the control flow graph; and
marking each created Ø-operand as live definitions out of the block, for each block in the control flow graph.

14. The processor-readable storage medium of claim 13, further comprising the instructions of:
merging the live definitions of each variable in the current block's predecessor blocks into the Ø-operand for the corresponding variable in the current block, for each block in the control flow graph.

15. The processor-readable storage medium of claim 14, further comprising the instructions of:
traversing the control flow graph until the leaf definitions; and
reducing the number of nested Ø-operands to a base representation in the live-in Ø-operands for each block in the control flow graph by arranging the leaf definitions into the current live-in Ø-operands.

16. The processor-readable storage medium of claim 12, further comprising performing the operations of renaming definitions of variables, allocating undefined Ø-operands, and using the allocated Ø-operands as live definitions, propagating the live definitions, for each block in the control flow graph in parallel.
